(19) United States
(12) Patent Application Publication
(10) Pub. No.: US 2026/0042442 A1
(43) Pub. Date: Feb. 12, 2026

(54) VEHICLE PEDAL MISAPPLICATION SAFETY ASSIST SYSTEM AND METHOD

(71) Applicants: HYUNDAI MOTOR COMPANY, Seoul (KR); KIA CORPORATION, Seoul (KR)

(72) Inventors: Seong Hwan Cheong, Hwaseong-si (KR); Sung Joon Yoon, Hwaseong-si (KR); Jin Hyeon Jeong, Hwaseong-si (KR); Yong Jae Lee, Hwaseong-si (KR); Kyu Beom Ko, Hwaseong-si (KR); Jeong Woo Ha, Hwaseong-si (KR)

(73) Assignees: HYUNDAI MOTOR COMPANY, Seoul (KR); KIA CORPORATION, Seoul (KR)

(21) Appl. No.: 18/974,402

(22) Filed: Dec. 9, 2024

(30) Foreign Application Priority Data
Aug. 12, 2024 (KR) 10-2024-0107400

(51) Int. Cl. B60W 30/09; B60W 10/10; B60W 10/18; B60W 30/095; B60W 50/14

(52) U.S. Cl. CPC B60W 30/09; B60W 10/10; B60W 10/18; B60W 30/0953; B60W 30/0956; B60W 50/14; B60W 2050/146; B60W 2540/10; B60W 2540/12; B60W 2554/80

(57) ABSTRACT

A vehicle pedal misapplication safety assist system and method are disclosed. The system includes an obstacle detection sensor mounted in a vehicle to detect an obstacle within a reference distance and an accelerator pedal sensor that detects a depression amount of an accelerator pedal. The system also includes a vehicle controller configured to perform control for limiting a driving force of the vehicle when a determination is made that the detected obstacle is within the reference distance and the depression amount of the accelerator pedal is detected, based on a detection signal of the obstacle detection sensor and a detection signal of the accelerator pedal sensor. The system further includes a brake controller configured to perform braking control according to a command from the vehicle controller when the driving force of the vehicle is limited and the distance to the detected obstacle reaches a braking setting distance.

### CROSS-REFERENCE TO RELATED APPLICATION

This application claims, under 35 U.S.C. § 119 (a), the benefit of and priority to Korean Patent Application No. 10-2024-0107400 filed on Aug. 12, 2024, the entire contents of which are incorporated herein by reference.

### BACKGROUND

### (a) Technical Field

The present disclosure relates to a vehicle pedal misapplication safety assist system and to a method therefor. More particularly, the present disclosure relates to a vehicle pedal misapplication safety assist system and method capable of preventing an accident caused by accidentally depressing an accelerator pedal instead of a brake pedal in a stopped, traveling, or starting situation.

### (b) Background Art

When an accelerator pedal is accidentally depressed instead of a brake pedal while a vehicle is stopped, traveling, or starting, the vehicle may accelerate and collide with another vehicle or an obstacle in front of the vehicle, thereby resulting in an accident.

As a related technique for solving this problem, a method for performing a braking operation of a brake system is performed when a distance to a front obstacle is within a reference distance while the vehicle is traveling. However, since a braking amount of the brake system increases momentarily, there is a concern that braking shock may be severely experienced by a driver and a passenger.

Further, when the distance to the front obstacle is not accurately detected while the vehicle is traveling, a vehicle collision accident may occur.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art. The present disclosure provides a vehicle pedal misapplication safety assist system and a method therefor. The present disclosure is capable of primarily limiting a driving force of the vehicle to reduce acceleration, when an obstacle within a reference distance is detected by an obstacle detection sensor provided in a vehicle and a depression amount of an accelerator pedal is detected. The present disclosure is further capable of secondarily performing braking control, when the vehicle is traveling closer to the obstacle detected by the obstacle detection sensor and reaches a braking setting distance. It is thereby possible to secondarily prevent collision with the obstacle and to make a driver recognize a situation of mistakenly depressing the accelerator pedal instead of a brake pedal.

In one aspect, the present disclosure provides a vehicle pedal misapplication safety assist system. The system includes an obstacle detection sensor that is mounted in a vehicle to detect an obstacle within a reference distance and includes an accelerator pedal sensor that detects a depression amount of an accelerator pedal. The system further includes a vehicle controller configured to perform control for limiting a driving force of the vehicle when a determination is made that the detected obstacle is within the reference distance and the depression amount of the accelerator pedal is detected, based on a detection signal of the obstacle detection sensor and a detection signal of the accelerator pedal sensor. The system also includes a brake controller configured to perform braking control according to a command from the vehicle controller when the driving force of the vehicle is limited and the distance to the detected obstacle reaches a braking setting distance.

In an embodiment, the obstacle detection sensor may include ultrasonic sensors mounted at front and rear positions of the vehicle.

In an embodiment, the vehicle controller may determine the accelerator pedal depression amount due to driver misapplication when it is determined that the detected obstacle is within the reference distance, and when the accelerator pedal depression amount is within a set time or the accelerator pedal depression amount continues at 10 to 90% for a set time, based on the detection signal of the accelerator pedal sensor.

In an embodiment, the system may further include an engine controller configured to perform control for limiting an engine torque to a creep torque corresponding to 0% of the accelerator pedal depression amount according to a command from the vehicle controller to limit the driving force of the vehicle.

In an embodiment, the system may further include a motor controller configured to perform control for limiting a motor torque to a creep torque corresponding to 0% of the accelerator pedal depression amount according to a command from the vehicle controller to limit the driving force of the vehicle.

In an embodiment, the vehicle controller may release the control for limiting the driving force of the vehicle and the braking control when a shift signal is received from a shift controller or a brake pedal depression amount detection signal is received from a brake pedal sensor.

In another aspect, the present disclosure provides a vehicle pedal misapplication safety assist method. The method includes detecting an obstacle within a reference distance from a vehicle, by an obstacle detection sensor and includes detecting a depression amount of an accelerator pedal, by an accelerator pedal sensor. The method further includes performing control, by a vehicle controller, for limiting a driving force of the vehicle, when it is determined that the detected obstacle is within the reference distance and the depression amount of the accelerator pedal is detected, based on a detection signal of the obstacle detection sensor and a detection signal of the accelerator pedal sensor. The method also includes performing braking control, by a brake controller, according to a command from the vehicle controller when the driving force of the vehicle is limited and the distance to the detected obstacle reaches a braking setting distance.

In an embodiment, the obstacle detection sensor may include an ultrasonic sensor that detects the obstacle detection signal within the reference distance to the vehicle controller.

In an embodiment, the vehicle controller may determine the accelerator pedal depression amount due to driver misapplication when it is determined that the detected obstacle is within the reference distance, and when the accelerator pedal depression amount is within a set time or the accelerator pedal depression amount continues at 10 to 90% for a set time, based on the detection signal of the accelerator pedal sensor.

In an embodiment, the performing control for limiting the driving force of the vehicle may include performing control, under control of an engine controller, for limiting an engine torque to a creep torque corresponding to an accelerator pedal depression amount of 0% according to a command from the vehicle controller to limit the driving force of the vehicle.

In an embodiment, the performing control for limiting the driving force of the vehicle may include performing control, under control of a motor controller, for limiting a motor torque to a creep torque corresponding to an accelerator pedal depression amount of 0% according to a command from the vehicle controller to limit the driving force of the vehicle.

In an embodiment, the method may further include performing, by the vehicle controller, a warning to notify of a possibility of accelerator pedal misapplication through a vehicle cluster or a display when the driving force of the vehicle is limited.

In an embodiment, the method may further include performing, by the vehicle controller, a warning to notify of a possibility of accelerator pedal misapplication through a vehicle cluster or a display when the braking control is performed.

In an embodiment, the method may further include releasing, by the vehicle controller, the control for limiting the driving force of the vehicle and the braking control when a shift signal is received from a shift controller or a brake pedal depression amount detection signal is received from a brake pedal sensor.

The above and other features of the present disclosure are discussed herein.

### BRIEF DESCRIPTION OF THE DRAWINGS

The above and other features of the present disclosure are described in detail with reference to certain embodiments thereof illustrated the accompanying drawings, which are given hereinafter by way of illustration only, and thus are not limitative of the present disclosure, and wherein:

FIG. 1 is a block diagram showing a configuration of a vehicle pedal misapplication safety assist system according to an embodiment of the present disclosure;

FIGS. 2 and 3 are schematic diagrams showing an operation flow of a vehicle pedal misapplication safety assist system according to an embodiment of the present disclosure; and

FIG. 4 is a flowchart illustrating a vehicle pedal misapplication safety assist method according to an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the technical concepts of the present disclosure are described in conjunction with various embodiments, it should be understood that the present description is not intended to limit the disclosure to the embodiments. On the contrary, the disclosure is intended to cover not only the disclosed embodiments, but also various alternatives, modifications, equivalents, and other embodiments, within the spirit and scope of the disclosure as defined by the appended claims.

It should be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the embodiments of the present disclosure.

In addition, it should be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers are used throughout the drawings to refer to the same or like parts. The terminology used herein is for the purpose of describing particular embodiments only and is not intended to limit embodiments of the disclosure. As used herein, the singular forms “a”, “an”, and “the” are intended to include the plural forms as well, unless the context clearly indicates otherwise. It should be further understood that the terms “comprise”, “include”, and “have” and variations thereof used herein specify the presence of stated components, steps, operations, and/or elements, but do not preclude the presence or addition of one or more other components, steps, operations, and/or elements.

When a component, device, element, controller, module, or the like (i.e., an apparatus) of the present disclosure is described as having a purpose or performing an operation, function, or the like, the component, device, element, controller, module, or the like should be considered herein as being “configured to” meet that purpose or to perform that operation or function. Each component, device, element, controller, module, or the like may separately embody or be included with a processor and a memory, such as a non-transitory computer readable media, as part of such an apparatus.

Hereinafter, embodiments of the present disclosure are described in detail with reference to the accompanying drawings.

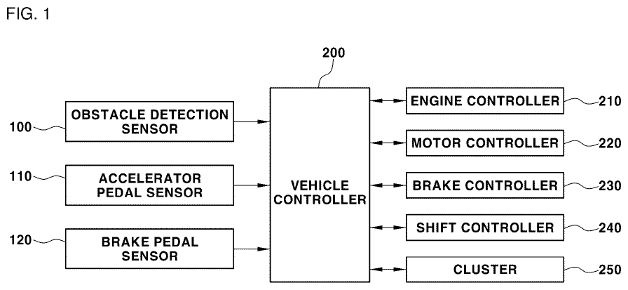

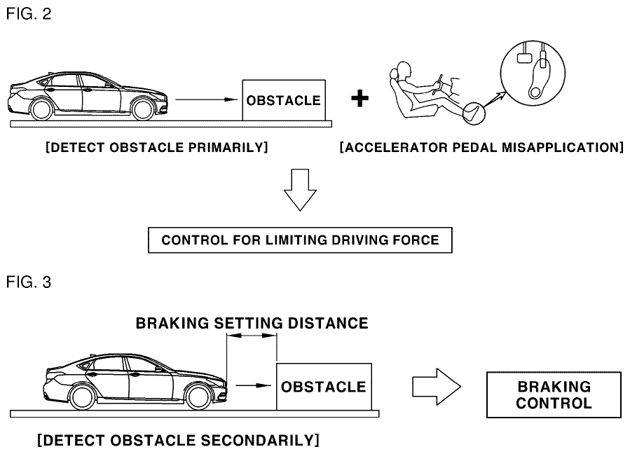

FIG. 1 is a block diagram showing a configuration of a vehicle pedal misapplication safety assist system according to an embodiment of the present disclosure. FIGS. 2 and 3 are schematic diagrams showing an operation flow of a vehicle pedal misapplication safety assist system according to an embodiment of the present disclosure.

Referring to FIG. 1, an obstacle detection sensor 100, an accelerator pedal sensor 110, and a brake pedal sensor 120 are connected to an input side of a vehicle controller 200 to transmit detection signals.

The vehicle controller 200 serves as a higher-level controller that commands various control signals to various lower-level controllers, such as an engine controller 210, a motor controller 220, a brake controller 230, and a shift controller 240 provided in a vehicle, and electrical components (e.g., a cluster 250).

Accordingly, the engine controller 210, the motor controller 220, the brake controller 230, and the shift controller 240 are connected to an output side of the vehicle controller 200 to communicate electrical signals.

The obstacle detection sensor 100 may be ultrasonic sensors that are provided at front and rear parts of the vehicle and detect an obstacle within a reference distance from the vehicle.

Specifically, to detect the obstacle within the reference distance from the vehicle, a device such as Radar (Radio Detection and Ranging), LiDAR (Light Detection and Ranging), or a camera may be used. However, since the Radar, LiDAR, or camera is expensive, it may be appropriate to use an ultrasonic sensor, which is relatively inexpensive and may be universally mounted in all types of vehicles.

The accelerator pedal sensor 110 is provided at a position near or below an accelerator pedal, detects a depression amount of the accelerator pedal, and transmits its detection signal to the vehicle controller 200.

The brake pedal sensor 120 is provided at a position near or below a brake pedal, detects a depression amount of the brake pedal, and transmits its detection signal to the vehicle controller 200.

The engine controller 210 is configured to control an engine torque of a hybrid vehicle or an internal combustion engine vehicle according to a command of the vehicle controller 200. The motor controller 220 is configured to control a motor torque of a hybrid vehicle or an electric vehicle according to a command of the vehicle controller 200.

For example, the engine controller 210 may perform control for limiting the engine torque to a creep torque corresponding to an accelerator pedal depression amount of 0% according to a command of the vehicle controller 200 to limit a driving force of the vehicle. The motor controller 220 may perform control for limiting the motor torque to a creep torque corresponding to an accelerator pedal depression amount of 0% according to a command of the vehicle controller 200 to limit a driving force of the vehicle.

The brake controller 230 is configured to perform braking control for an integrated electronic brake (IEB).

For example, the brake controller 230 may perform braking control according to a command of the vehicle controller 200 when the driving force of the vehicle is limited and a distance to an obstacle detected by the obstacle detection sensor 100 reaches a braking setting distance.

In particular, the vehicle controller 200 performs control for limiting the driving force of the vehicle when it is determined that the obstacle exists within the reference distance from the vehicle and the accelerator pedal depression amount is detected, based on a detection signal from the obstacle detection sensor 100 and a detection signal from the accelerator pedal sensor 110.

The vehicle controller 200 receives the detection signal from the obstacle detection sensor 100 to determine whether there is an obstacle that may collide with the vehicle within the reference distance. The vehicle controller 200 further receives the detection signal from the accelerator pedal sensor 110 to determine, when an accelerator pedal depression amount is within a set time (e.g., 0.2 seconds) or the accelerator pedal depression amount continues at 10 to 90% for a set time, that there is an accelerator pedal depression amount due to driver misapplication.

Accordingly, as shown in FIG. 2, when it is determined that the detected obstacle exists within the reference distance from the vehicle and there is the accelerator pedal depression amount due to the driver misapplication, the vehicle controller 200 transmits a command for limiting the driving force of the vehicle to the engine controller 210 or the motor controller 220. The vehicle controller 200 thereby primarily limiting the driving force of the vehicle through the control of the engine controller 210 or the motor controller 220.

For example, in the case of the hybrid vehicle or the internal combustion engine vehicle, the engine controller 210 performs control for limiting an engine output torque to a creep torque corresponding to an accelerator pedal depression amount of 0% according to a command of the vehicle controller 200 to limit the driving force of the vehicle. Thus, it is possible to reduce the acceleration of the vehicle and to perform only creep driving to prevent rolling on an uphill slope.

Alternatively, in the case of the hybrid vehicle or the electric vehicle, the motor controller 220 performs control for limiting a motor output torque to a creep torque corresponding to an accelerator pedal depression amount of 0% according to a command of the vehicle controller 200 to limit the driving force of the vehicle. Thus, it is possible to reduce the acceleration of the vehicle and to perform only creep driving to prevent rolling on an uphill slope.

When the obstacle is detected within the reference distance by the obstacle detection sensor 100 while the vehicle is stopped or traveling and the accelerator pedal depression amount is detected, the driving force of the vehicle may be primarily limited to reduce the acceleration. This prevents collision with the obstacle and makes a driver recognize a situation of mistakenly depressing the accelerator pedal instead of the brake pedal. Limiting the driving force of the vehicle may thereby prevent misapplication of the accelerator pedal.

Even when the above-described control for limiting the driving force of the vehicle is performed, as the vehicle is traveling closer to the obstacle and it is determined that the distance to the obstacle detected by the obstacle detection sensor 100 reaches the braking setting distance, the vehicle controller 200 transmits a braking control command to the brake controller 230.

As shown in FIG. 3, when it is determined that the distance to the obstacle detected by the obstacle detection sensor 100 reaches the braking setting distance, the brake controller 230 performs braking control according to the command from the vehicle controller 200. Thus, deceleration is first performed according to the control for limiting the driving force. Then, braking for stopping the vehicle is performed secondarily to thereby completely prevent collision with the obstacle.

Since the braking control is performed after the primary deceleration due to the control for limiting the driving force of the vehicle, braking shock experienced by the driver and passenger may be reduced.

When a shift signal is received from the shift controller 240 or a brake pedal depression amount detection signal is received from the brake pedal sensor 120, the vehicle controller 200 may release the control for limiting the driving force of the vehicle and the braking control.

More specifically, when the shift signal is received from the shift controller 240 or the brake pedal depression amount detection signal is received from the brake pedal sensor 120, the vehicle controller 200 determines that the driver clearly recognizes the situation of mistakenly depressing the accelerator pedal instead of the brake pedal and releases the control for limiting the driving force of the vehicle and the braking control.

Hereinafter, a vehicle pedal misapplication safety assist method according to an embodiment of the present disclosure, based on the above-mentioned configuration, is described.

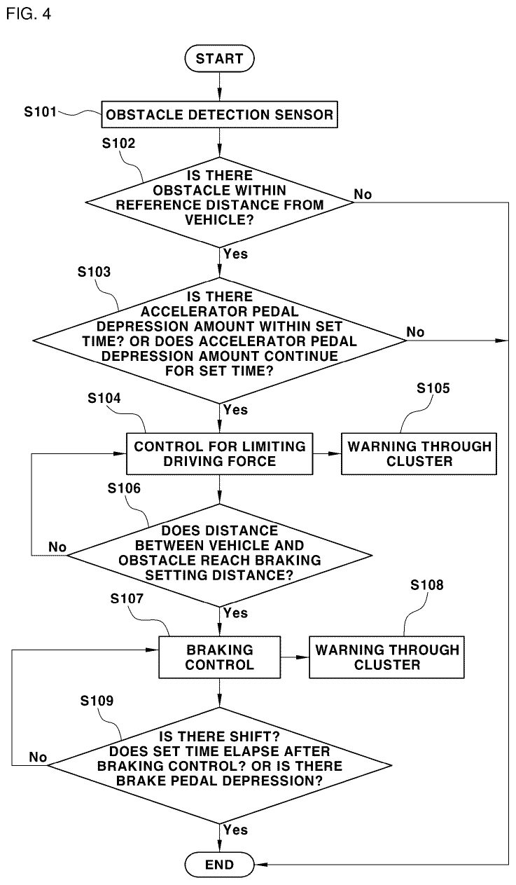

FIG. 4 is a flowchart showing a vehicle pedal misapplication safety assist method according to an embodiment of the present disclosure.

First, sensor information is acquired while the vehicle is stopped, starting, or traveling, by the vehicle controller 200 (S101).

Specifically, an obstacle within a reference distance from the vehicle is detected by the obstacle detection sensor 100 while the vehicle is stopped, starting, or traveling. A depression amount of an accelerator pedal is detected by the accelerator pedal sensor 110. Then, a detection signal from the obstacle detection sensor 100 and a detection signal from the accelerator pedal sensor 110 are transmitted to the vehicle controller 200.

Then, the vehicle controller 200 determines whether the obstacle exists within the reference distance from the vehicle based on the detection signal from the obstacle detection sensor 100 (S102). The vehicle controller 200 also determines whether there is the accelerator pedal depression amount based on the detection signal from the accelerator pedal sensor 110 (S103).

For example, the vehicle controller 200 determines that there is an obstacle that may collide with the vehicle within the reference distance based on the detection signal from the obstacle detection sensor 100. Further, the vehicle controller 200 receives the detection signal from the accelerator pedal sensor 110 and determines, when the accelerator pedal depression amount is within a set time (0.2 seconds) or the accelerator pedal depression amount continues at 10 to 90% for a set time, that there is the accelerator pedal depression amount due to driver misapplication.

When it is determined that the detected obstacle exists within the reference distance from the vehicle and that there is the accelerator pedal depression amount due to the driver misapplication, control for limiting a driving force of the vehicle is performed by the vehicle controller 200 (S104).

More specifically, when it is determined that the detected obstacle exists within the reference distance from the vehicle and there is the accelerator pedal depression amount due to the driver misapplication, the vehicle controller 200 transmits a command to limit the driving force of the vehicle to the engine controller 210 or the motor controller 220. The command thereby primarily limits the driving force of the vehicle under the control of the engine controller 210 or the motor controller 220.

For example, in the case of a hybrid vehicle or an internal combustion engine vehicle equipped with an engine, the engine controller 210 performs control for limiting an engine output torque to a creep torque corresponding to an accelerator pedal depression amount of 0% according to a command from the vehicle controller 200 to limit the driving force of the vehicle. Thus, the acceleration of the vehicle may be reduced and only creep driving for preventing rolling on an uphill slope may be performed.

Alternatively, in the case of a hybrid vehicle or an electric vehicle equipped with a drive motor, the motor controller 220 performs control for limiting a motor output torque to a creep torque corresponding to an accelerator pedal depression amount of 0% according to a command from the vehicle controller 200 to limit the driving force of the vehicle. Thus, the acceleration of the vehicle may be reduced and only creep driving for preventing rolling on an uphill slope may be performed.

When the obstacle is detected within the reference distance by the obstacle detection sensor 100 while the vehicle is stopped, starting, or traveling and the accelerator pedal depression amount is detected, the driving force of the vehicle is primarily limited to reduce the acceleration. Limiting the driving force makes it possible to prevent collision with the obstacle and makes the driver recognize a situation of mistakenly depressing the accelerator pedal instead of the brake pedal, thereby preventing misapplication of the accelerator pedal.

In addition, when the driving force of the vehicle is limited, a warning for notifying of the possibility of an accelerator pedal misapplication through the vehicle cluster 250 or a display by the vehicle controller 200 may be further performed (S105).

Accordingly, the driver may clearly recognize the situation of mistakenly depressing the accelerator pedal instead of the brake through the warning on the cluster 250 or the display.

Then, the vehicle controller 200 determines whether a distance to the obstacle detected by the obstacle detection sensor 100 reaches a braking setting distance (S106).

Even when the above-described control for limiting the driving force of the vehicle is performed, as the driver continuously depresses the accelerator pedal, since the distance between the vehicle and the obstacle may become closer and shorter than the reference distance, the vehicle controller 200 determines whether the distance to the obstacle detected by the obstacle detection sensor 100 reaches a braking set distance that is smaller than the reference distance.

As a result, when it is determined that the distance to the obstacle detected by the obstacle detection sensor 100 reaches the braking setting distance, the vehicle controller 200 commands braking control with respect to the brake controller 230.

Accordingly, the braking control of the brake controller 230 is performed according to the command of the vehicle controller 200 (S107).

For example, the brake controller 230 performs braking control with respect to an integrated electronic brake (IEB), to thereby stop the vehicle.

Since the deceleration is primarily performed by the control for limiting the driving force and then the braking is performed secondarily to stop the vehicle, it is possible to completely prevent collision with the obstacle. Further, since the braking control is performed after the primary deceleration due to the control for limiting the driving force of the vehicle, it is possible to reduce braking shock to the driver and passenger.

In addition, when the braking control is performed by the brake controller 230, a warning for notifying of the possibility of the accelerator pedal misapplication through the vehicle cluster 250 or the display may be further performed, by the vehicle controller 200 (S108).

Accordingly, the driver may clearly recognize the situation of mistakenly depressing the accelerator pedal instead of the brake through the warning on the cluster 250 or the display.

In this regard, when a gear lever is shifted to P, etc. after the braking control, it can be determined that the driver clearly recognizes the situation of misapplication of the accelerator pedal and changes gears. Additionally, it can be determined that the driver clearly recognizes the situation of misapplication of the accelerator pedal for a set period of time as the vehicle is stopped by the braking control. Further, when the brake pedal is depressed after the braking control, it can be determined that the driver clearly recognizes the situation of misapplication of the accelerator pedal and depresses the brake pedal.

Accordingly, the vehicle controller 200 determines whether the driver shifts gears after the braking control, whether the set time elapses after the braking control, or whether the driver depresses the brake pedal after the braking control (S109).

As a result, when a shift signal is received from the shift controller 240, when the set time elapses after the braking control, or when a brake pedal depression amount detection signal is received from the brake pedal sensor 120, the vehicle controller 200 releases the control for limiting the driving force of the vehicle and the braking control.

According to the present disclosure, the following effects are achieved.

First, when an obstacle within a reference distance is detected by an obstacle detection sensor while a vehicle is stopped, starting, or traveling and a depression amount of an accelerator pedal is detected, a driving force of the vehicle is primarily limited to reduce acceleration, thereby making it possible to primarily prevent collision with the obstacle. The driving force of the vehicle is also limited to make a driver recognize a situation of mistakenly depressing the accelerator pedal instead of the brake pedal, thereby preventing misapplication of the accelerator pedal.

Second, even when the control for limiting the driving force of the vehicle is performed, as the vehicle is traveling closer to the obstacle detected by the obstacle detection sensor and reaches a braking setting distance, braking control is secondarily performed, thereby making it possible to secondarily prevent collision with the obstacle. Further, by performing braking control after the primary deceleration due to the control for limiting the driving force of the vehicle, it is possible to reduce braking shock.

The technical concepts of the present disclosure have been described in detail with reference to embodiments thereof. However, it should be appreciated by those having ordinary skill in the art that various modifications and improvements may be made in these embodiments without departing from the principles and spirit of the present disclosure, the scope of which is defined in the appended claims and their equivalents.

What is claimed is:

1. A vehicle pedal misapplication safety assist system, the system comprising:
an obstacle detection sensor that is mounted in a vehicle to detect an obstacle within a reference distance;
an accelerator pedal sensor that detects a depression amount of an accelerator pedal;
a vehicle controller configured to perform control for limiting a driving force of the vehicle when a determination is made that the detected obstacle is within the reference distance and the depression amount of the accelerator pedal is detected, based on a detection signal of the obstacle detection sensor and a detection signal of the accelerator pedal sensor; and
a brake controller configured to perform braking control according to a command from the vehicle controller when the driving force of the vehicle is limited and the distance to the detected obstacle reaches a braking setting distance.

2. The system according to claim 1, wherein the obstacle detection sensor comprises ultrasonic sensors mounted at front and rear positions of the vehicle.

3. The system according to claim 1, wherein the vehicle controller determines that there is the depression amount of the accelerator due to driver misapplication when a determination is made that the detected obstacle is within the reference distance, and when the depression amount of the accelerator pedal is within a set time or continues at 10 to 90% for a set time, based on the detection signal of the accelerator pedal sensor.

4. The system according to claim 1, further comprising:
an engine controller configured to perform control for limiting an engine torque to a creep torque corresponding to 0% of the depression amount of the accelerator pedal according to a command from the vehicle controller to limit the driving force of the vehicle.

5. The system according to claim 1, further comprising:
a motor controller configured to perform control for limiting a motor torque to a creep torque corresponding to 0% of the depression amount of the accelerator pedal according to a command from the vehicle controller to limit the driving force of the vehicle.

6. The system according to claim 1, wherein the vehicle controller releases the control for limiting the driving force of the vehicle and the braking control when a shift signal is received from a shift controller or a brake pedal depression amount detection signal is received from a brake pedal sensor.

7. A vehicle pedal misapplication safety assist method, the method comprising:
detecting an obstacle within a reference distance from a vehicle, by an obstacle detection sensor;
detecting a depression amount of an accelerator pedal, by an accelerator pedal sensor;
performing control for limiting a driving force of the vehicle when a determination is made that the detected obstacle is within the reference distance and the depression amount of the accelerator pedal is detected, based on a detection signal of the obstacle detection sensor and a detection signal of the accelerator pedal sensor, by a vehicle controller; and
performing braking control according to a command from the vehicle controller when the driving force of the vehicle is limited and the distance to the detected obstacle reaches a braking setting distance, by a brake controller.

8. The method according to claim 7, wherein the obstacle detection sensor comprises an ultrasonic sensor that detects the obstacle detection signal within the reference distance to the vehicle controller.

9. The method according to claim 7, wherein the vehicle controller determines the depression amount of the accelerator pedal due to driver misapplication when a determination is made that the detected obstacle is within the reference distance, and when the depression amount of the accelerator pedal is within a set time or continues at 10 to 90% for a set time, based on the detection signal of the accelerator pedal sensor.

10. The method according to claim 7, wherein performing control for limiting the driving force of the vehicle comprises performing, under the control of an engine controller, control for limiting an engine torque to a creep torque corresponding to the depression amount of the accelerator pedal of 0% according to a command from the vehicle controller to limit the driving force of the vehicle.

11. The method according to claim 7, wherein performing control for limiting the driving force of the vehicle comprises performing, under control of a motor controller, control for limiting a motor torque to a creep torque corresponding to the depression amount of the accelerator pedal of 0% according to a command from the vehicle controller to limit the driving force of the vehicle.

12. The method according to claim 7, further comprising:
performing, by the vehicle controller, a warning to notify of a possibility of accelerator pedal misapplication through a vehicle cluster or a display when the driving force of the vehicle is limited.

13. The method according to claim 7, further comprising:
performing, by the vehicle controller, a warning to notify of a possibility of accelerator pedal misapplication through a vehicle cluster or a display when the braking control is performed.

14. The method according to claim 7, further comprising:
Releasing, by the vehicle controller, the control for limiting the driving force of the vehicle and the braking control when a shift signal is received from a shift controller or a brake pedal depression amount detection signal is received from a brake pedal sensor.
